(19) United States
(12) Patent Application Publication
(10) Pub. No.: US 2025/0057165 A1
(43) Pub. Date: Feb. 20, 2025

(54) METHOD OF FORMING A READY-TO-USE AGRICULTURAL COMPOSITION COMPRISING GLUFOSINATE

(71) Applicant: NOURYON CHEMICALS INTERNATIONAL B.V., Amsterdam (NL)

(72) Inventors: Shawn ZHU, Stormville, NY (US); Turgut BATTAL, Stora Hoga (SE)

(73) Assignee: NOURYON CHEMICALS INTERNATIONAL B.V., Amsterdam (NL)

(21) Appl. No.: 18/721,360

(22) PCT Filed: Dec. 20, 2022
(86) PCT No.: PCT/EP2022/087098

§ 371 Date: Jun. 18, 2024

Related U.S. Application Data
(60) Provisional application No. 63/265,851, filed on Dec. 22, 2021.

(51) Int. Cl. A01N 57/20; A01N 25/04; A01P 13/00

(52) U.S. Cl. CPC A01N 57/20; A01N 25/04; A01P 13/00

(57) ABSTRACT

A method of forming a ready-to-use agricultural composition comprising glufosinate includes the step of:
combining: (1) water, (2) at least one linear or branched C6-13 alcohol or alkoxylate thereof, (3) a salt of glufosinate, and (4) at least one linear or branched C8-13 alkyl ether sulfate, to form the ready-to-use agricultural composition,
wherein the concentration of each of (2), (3), and (4) is independently from about 0.05 to about 1, weight percent, based on a total weight of the ready-to-use agricultural composition.

### CROSS-REFERENCE TO RELATED APPLICATIONS

This application is a U.S. National-Stage entry under 35 U.S.C. § 371 based on International Application No. PCT/EP2022/087098, filed Dec. 20, 2022, which was published under PCT Article 21(2) and which claims priority to U.S. Provisional Application No. 63/265,851, filed Dec. 22, 2021, which are all hereby expressly incorporated herein in their entirety by reference.

### TECHNICAL FIELD

The present disclosure generally relates to a method of forming a ready-to-use agricultural composition comprising glufosinate. More specifically, this disclosure is related to a method of forming a ready-to-use agricultural composition that includes an alcohol alkoxylate which reduces cost but maintains efficacy when compared to a commercially available glufosinate formulation.

### BACKGROUND

Glufosinate is a broad spectrum herbicide. It is known that the activity of glufosinate can be improved in many cases by the addition of surfactants. Examples can be found in the art such as DE 2,725,823 and 2,554,532, U.S. Pat. No. 4,400,196, CA1333226, U.S. Pat. No. 9,215,868, U.S. Pat. No. 10,716,304, EP-A-0048436, EP-A-00336151, EP-A-1093722, and WO2017025851. The surfactants include alcohol ethoxylates, alkyl ether sulfates, alkyldimethyl-, fatty acid admidopropyldimethyl-, fatty acid amido ethyldimethylamine oxides, betaines of cocodimethylaminoacetic acid and cocoaminopropionic acid, alkanesulfonates and mixtures thereof with fatty alcohol polyglycol ether sulfonsuccinic acid monoesters or alkyl ether sulfates, alkylsulfonsuccinic acid monoesters or fatty alcohol polyglycol ether sulfosuccinic acid monoesters and fatty alcohol polyglycol ether sulfosuccinic acid esters and their mixtures with alkyl ether sulfates, alpha-olefinsulfonates and mixtures thereof with fatty alcohol polyglycol ether sulfates, fatty alcohol polyglycol ether sulfonsuccinic acid monoesters or alkylsulfosuccinic acid monoesters, sulfonates which can be used being alkali metal salts, ammonium salts, and alkaline earth metal salts or substituted alkyl- or alkanolamine salts of the corresponding sulfonic or sulfuric acids.

Though many types of surfactants have described as having the ability to enhance the efficacy of glufosinate, only commercial glufosinate products including alkyl ether sulfate, in particular, lauryl ether sulfate (having a small number of ethylene oxide units) are available. Accordingly, it is doubtful how efficacious most surfactants are at enhancing the efficacy of glufosinate.

Moreover, the art, such as U.S. Pat. No. 9,215,868, recognizes that aqueous formulations of glufosinate-ammonium are known, for example, from EP-A-0048436, EP-A-00336151 and EP-A-1093722. Here, preference is given to using alkyl ether sulfates having alkyl chains length of C12-C16 with 1 to 10 ethyleneoxy units which are suitable for enhancing the biological action of glufosinate applied to the green parts of plants. The specific mechanism of action of the alkyl ether sulfates in this context is unknown. Compared to the alkyl ether sulfates mentioned, other additives having comparable surfactant properties (spray adherence, spreading on the target plants) including other anionic surfactants reduce the activity. Substances having solvent character, such as polyether glycols, glycerol, mineral oil, mineral oil concentrates, polymers, buffer and other substances do not display any comparable activity either.

More specifically, WO2017025851 discloses a solid glufosinate composition comprising glufosinate and at least two surfactants selected from amine, alkoxylated fatty alcohols, and alkylated vegetable oils.

U.S. Pat. No. 10,716,304 discloses an aqueous glufosinate composition comprising 20-35% glufosinate, alkyl ether sulfates, alkyl poly glycosides (APG), and an organic solvent such as 1-Methoxy-2-propanol (also known as propylene glycol monomethyl ether). The main purpose of using APG and the organic solvent is to prevent crystal formation at low temperature.

CN103269581B teaches that certain alcohol ethoxylates are able to improve formulation stability in composition including water, glufosinate (NH4 and Na salts), SLES-2 (sodium lauryl ether sulfate-2EO), and propylene glycol monomethyl ether. This reference focuses on a stable aqueous herbicide formulation (as evidenced by a lack of precipitate formation at −5° C. for 3 days) comprising a water soluble herbicide (sodium or ammonium glufosinate), 5˜50% ether sulfates, 1˜30% organic solvent, 0.1˜20% alcohol ethoxylates. The suitable organic solvents are propylene glycol monomethyl ether, isopropyl alcohol, butanol, tetrahydrofurfuryl alcohol, and dipropylene glycol. Example 1 in CN103269581B includes 17% sodium glufosinate, 10.5% SLES-2, 10% propylene glycol monomethyl ether, 2% C8-4EO, and water to 100%. Example 1 does not show a precipitate after 3 days at −5° C. Examples 2-6 include only 11% glufosinate. In Examples 7-12, the concentrations of glufosinate have to be kept low (about 6-11%) in order for the formulations to be stable at −5° C. In this reference, there is no data presented evaluating the efficacy of C8-4EO compounds at −5° C. Instead, it can be shown that a formulation including 17% NH4-glufosinate, 10.5% SELS, 10% butanol (a suitable organic solvent), 5% 2-ethylhexyl-4EO, and water (to 100%) does not form precipitates but separates into two liquid phases after resting a few hours at room temperature. CN103269581B does not disclose whether the bioefficacy of glufosinate can be improved after using alcohol ethoxylates.

Many aqueous glufosinate commercial products are currently available as set forth below:

| | Ingredient | | | | |
|---|---|---|---|---|---|
| | NH4 | | 1-Methoxy- | Alkyl | Surfactant |
| Brand | glufosinate | SLES | 2-propanol | Polyglucoside | Blend |
| Liberty 280 g/l | 24.5 | 31.6 | 1 | 9.8 | — |
| BASTA 200 g/l | 18.02 | 25 | 1-10 | — | — |
| Buster | 18.02 | Unknown | 9.91 | — | — |
| BASTA SL150 | 13.5 | >25 | <15 | — | — |
| 1X15L BOT TW | | | | | |
| IGNITE ® SN | 13.5 | 58.5 | 10 | — | — |
| FINALE VU | 11.3 | 12.7 | 10 | — | — |
| FMC Glufosinate 200 | 200 g/l | Unknown | 10-30 | — | — |
| Glufosinate 200 | 20 | Unknown | 10-30 | — | — |
| AGPRO | 200 g/l | Unknown | <110 g/l | — | — |
| Glufosinate 200 | | | | | |
| Forfeit 280 | 24.5 | Unknown | Unknown | Unknown | — |
| Genfarm | 20 | Unknown | 11 | — | — |
| Glufosinate 200 | | | | | |
| Tailout | 13.5 | >10 | <15 | — | — |
| TOTAL | 20-30 | Unknown | 8.93 | — | — |
| Interline | 24.5 | Unknown | 8.93 | — | — |
| Refer ® 280SL | 24.5 | Unknown | | — | — |
| Cheetah Pro | 23.75-25.3 | — | — | — | 36-38 |
| Scout | 24.5 | — | — | — | 36-38 |
| Cheetah | 24.6-26.1 | Unknown | — | — | — |
| Nullify A/P | 24.5 | Unknown | — | — | — |
| X-Out | 24.5 | Unknown | — | — | — |

These commercial glufosinate products offer proven weed control efficacy. However, these products are expensive.

Accordingly, there remains an opportunity to develop a composition that performs as well as the commercially available products, e.g. relative to efficacy, but at less cost and with less amounts of certain expensive components therein. Furthermore, other desirable features and characteristics of the present disclosure will become apparent from the subsequent detailed description of the present disclosure and the appended claims, taken in conjunction with the accompanying drawings and this background of the present disclosure.

### BRIEF SUMMARY

This disclosure provides a method of forming a ready-to-use agricultural composition including glufosinate, the method including the step of:
combining: (1) water, (2) at least one linear or branched C6-13 alcohol or alkoxylate thereof, (3) a salt of glufosinate, and (4) at least one linear or branched C8-13 alkyl ether sulfate, to form the ready-to-use agricultural composition,
wherein the concentration of each of (2), (3), and (4) is independently from about 0.05 to about 1, weight percent actives, based on a total weight of the ready-to-use agricultural composition.

It has been surprisingly discovered that replacing part of a commercially available glufosinate formulation that includes at least one linear or branched C8-13 alkyl ether sulfate by at least one linear or branched C6-13 alcohol or alkoxylate thereof produces a composition that can achieve similar or equal efficacy results compared to the commercially available glufosinate formulation itself. Alcohol alkoxylates are much less expensive than commercially available glufosinate formulations such that cost of the new composition is much less for end users. This allows the users to save money and/or to use additional amounts of glufosinate for increased pest control. Moreover, the new composition also allows for decreased amounts of the actual glufosinate to be used, if so desired. Accordingly, this disclosure describes a method which can lower the cost of using commercial glufosinate products while maintaining the efficacy.

### DETAILED DESCRIPTION

The following detailed description is merely exemplary in nature and is not intended to limit the current method or composition. Furthermore, there is no intention to be bound by any theory presented in the preceding background or the following detailed description. It is to be appreciated that all numerical values as provided herein, save for the actual examples, are approximate values with endpoints or particular values intended to be read as “about” or “approximately” the value as recited.

Embodiments of the present disclosure are generally directed to agricultural compositions and methods for forming the same. For the sake of brevity, conventional techniques related to the formation of such agricultural compositions may not be described in detail herein. Moreover, the various tasks and process steps described herein may be incorporated into a more comprehensive procedure or process having additional steps or functionality not described in detail herein. In particular, various steps in the manufacture of agricultural compositions are well-known and so, in the interest of brevity, many conventional steps will only be mentioned briefly herein or will be omitted entirely without providing the well-known process details. In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, all values set forth herein may be alternatively described as approximate or “about.” It is contemplated that all isomers and chiral options for each compound described herein are hereby expressly contemplated for use herein. Moreover, it is also contemplated herein that any weight percents (wt %) described herein may be alternatively described as weight percent actives. It is further contemplated that the terminology “consisting essentially of” may describe various embodiments that are free of one or more components that are not described herein or that are described herein as optional, e.g. polymers, surfactants, pesticides, other herbicides, fungicides, additives, etc. It is to be appreciated that all numerical values as provided herein, save for the actual examples, are approximate values with endpoints or particular values intended to be read as “about” or “approximately” the value as recited.

In various embodiments, this disclosure provides a method of forming a ready-to-use agricultural composition including glufosinate, the method including the step of:
combining: (1) water, (2) at least one linear or branched C6-13 alcohol or alkoxylate thereof, (3) a salt of glufosinate, and (4) at least one linear or branched C8-13 alkyl ether sulfate, to form the ready-to-use agricultural composition,
wherein the concentration of each of (2), (3), and (4) is independently from about 0.05 to about 1, weight percent actives, based on a total weight of the ready-to-use agricultural composition.

In other embodiments, this disclosure provides a method of forming a ready-to-use agricultural composition including glufosinate, the method including the step of:
Combining: water (1), at least one linear or branched C6-13 alcohol or alkoxylate thereof (2), and a concentrated glufosinate formulation comprising glufosinate (3) and a C8-13 alkyl ether sulfate (4), wherein, after combining all the components in the ready-to-use agricultural composition, the concentrations of (2), (3) and (4) are each independently from about 0.05 to about 1, weight percent actives.

### Composition

This disclosure provides a ready-to-use agricultural composition which may or may not be formed from any method described herein. Alternatively, the ready-to-use agricultural composition may be alternatively described as an in-can ready-to-use composition or a tank-mix ready-to use spray composition, as would be understood by the skilled person. Therefore, in various non-limiting embodiments, any component described herein can be present in the in-can ready-to-use composition and a tank-mix ready-to-use spray composition, in any amount described herein. Moreover, all values and ranges of values, both whole and fractional, including and between all values and ranges of values described herein, are hereby expressly contemplated for use herein in various non-limiting embodiments.

The composition typically includes (1) water, (2) at least one linear or branched C6-13 alcohol or alkoxylate thereof, (3) a salt of glufosinate, and (4) at least one linear or branched C8-13 alkyl ether sulfate. The amounts of each of (1)-(4) tend to independently vary depending on the type of composition that is formed. Again, these amounts may be chosen and customized by one of skill in the art within the scope of this disclosure.

In various embodiments, in the ready-to-use agricultural composition the following amounts are typically contemplated:
(2) at least one linear or branched C6-13 alcohol or alkoxylate thereof present in an amount of from about 0.05 to about 1, about 0.1 to about 0.95, about 0.15 to about 0.9, about 0.2 to about 0.85, about 0.25 to about 0.8, about 0.3 to about 0.75, about 0.35 to about 0.7, about 0.4 to about 0.65, about 0.45 to about 0.6, or about 0.5 to about 0.55, weight percent actives based on a total weight of the ready-to-use agricultural composition;
(3) a salt of glufosinate present in an amount of about 0.05 to about 1, about 0.1 to about 0.95, about 0.15 to about 0.9, about 0.2 to about 0.85, about 0.25 to about 0.8, about 0.3 to about 0.75, about 0.35 to about 0.7, about 0.4 to about 0.65, about 0.45 to about 0.6, or about 0.5 to about 0.55, weight percent actives based on a total weight of the ready-to-use agricultural composition;
(4) at least one linear or branched C8-13 alkyl ether sulfate present in an amount of from about 0.05 to about 1, about 0.1 to about 0.95, about 0.15 to about 0.9, about 0.2 to about 0.85, about 0.25 to about 0.8, about 0.3 to about 0.75, about 0.35 to about 0.7, about 0.4 to about 0.65, about 0.45 to about 0.6, or about 0.5 to about 0.55, weight percent actives based on a total weight of the ready-to-use agricultural composition; and
(5) a balance of water and optionally one of more additives, solvents, surfactants, etc. described herein. In various embodiments, all values and ranges of values, including and between those described above, are hereby expressly contemplated for use herein in various non-limiting embodiments.

In one embodiment, the concentration of each of (2), (3), and (4) is independently from about 0.1 to about 0.7 weight percent actives, based on a total weight of the composition.

In another embodiment, the concentration of each of (2), (3), and (4) is independently from about 0.2 to about 0.4 weight percent actives, based on a total weight of the composition.

In another embodiment, the concentration of each of (2), (3), and (4) is independently from about 0.2 to about 0.6 weight percent actives, based on a total weight of the composition.

In another embodiment, the concentration of each of (2), (3), and (4) is independently from about 0.3 to about 0.5 weight percent actives, based on a total weight of the composition.

In various embodiments, the composition may be, include, consist essentially or, or consist of (1)-(4).

In one embodiment, the composition includes (1)-(4).

In another embodiment, the composition consists essentially of (1)-(4). It is contemplated that the terminology “consists essentially of” describes embodiments that are free of one or more components that are not described herein and/or are described herein as optional, e.g. polymers, surfactants, pesticides, herbicides, fungicides, additives, etc.

In another embodiment, the composition consists essentially of (1)-(4) and optionally includes one of more additives, solvents, surfactants, etc. described herein.

In still another embodiment, the composition consists of (1)-(4).

In other embodiments, the composition includes (1)-(4) and one or more additional components described herein.

In other embodiments, the composition consists essentially of (1)-(4) and one or more additional components described herein. It is contemplated that the terminology “consists essentially of” describes embodiments that are free of one or more components that are not described herein, e.g. polymers, surfactants, pesticides, herbicides, fungicides, additives, etc.

In still other embodiments, the composition consists of (1)-(4) and one or more additional components described herein.

In various embodiments, the composition may be a hazy but homogeneous liquid or a clear solution, as visually determined. If the composition is a hazy liquid, it typically has sufficient stability (up to 30 minutes without visual phase separation) before application. If separation occurs after 30 minutes, the composition is typically able to be mixed back to a homogeneous hazy state with gentle agitation. In various embodiments, the composition is a visually clear liquid when evaluated at temperatures between about 0° C. and about 54° C. If the composition is a visually clear solution, it can typically be stored for an extended period before use.

### (1) Water

As first described above, the composition includes water. The amount of water included in the composition can vary as chosen by one of skill in the art and may be any amount known in the art. The amount of water may be included in amount known as “q.s.” or in amount such that a total amount of (1)-(4) is 100 weight percent. Alternatively, the amount of water may be such that the total weight of (1)-(4) plus amounts of any additional components described herein totals 100 weight percent. Numerically, the amount of water may be described as about 1 to about 99.9, about 1 to about 99, about 5 to about 95, about 10 to about 90, about 15 to about 85, about 20 to about 80, about 25 to about 75, about 30 to about 70, about 35 to about 65, about 40 to about 60, about 45 to about 55, or about 50, weight percent based on a total weight of the composition. In various non-limiting embodiments, all values, both whole and fractional, between and including all of the above, are hereby expressly contemplated for use herein.

### (2) At Least One Linear or Branched C6-13 Alcohol or Alkoxylate Thereof

Referring now to (2), the at least one linear or branched C6-13 alcohol or alkoxylate thereof is not particularly limited and may be any known in the art. The disclosure may utilize one or more than one, or may be free of one or more than one, of a linear C6-13 alcohol, a branched C6-C13 alcohol, an alkoxylate of a linear C6-13 alcohol, and/or an alkoxylate of a branched C6-13 alcohol, so long as at least one of the above is present.

This component may be, include, consist essentially of, or consist of, the at least one linear or branched C6-13 alcohol or alkoxylate thereof. For example, this component may be, include, consist essentially of, or consist of, a linear alcohol having 6, 7, 8, 9, 10, 11, 12, or 13 carbon atoms or any range thereof.

Alternatively, this component may be, include, consist essentially of, or consist of, a branched alcohol having 6, 7, 8, 9, 10, 11, 12, or 13 carbon atoms or any range thereof.

In other embodiments, this component may be, include, consist essentially of, or consist of, an alkoxylate of a linear alcohol having 6, 7, 8, 9, 10, 11, 12, or 13 carbon atoms or any range thereof.

Alternatively, this component may be, include, consist essentially of, or consist of, an alkoxylate of a branched alcohol having 6, 7, 8, 9, 10, 11, 12, or 13 carbon atoms or any range thereof.

All isomers of the aforementioned compounds are also expressly contemplated for use herein. This component may be alternatively described as a non-ionic surfactant. In various non-limiting embodiments, all values, both whole and fractional, between and including all of the above, are hereby expressly contemplated for use herein.

It is contemplated that the at least one linear or branched C6-13 alcohol may be utilized to the exclusion of the alkoxylate. It is also contemplated that the alkoxylate may be utilized to the exclusion of the at least one linear or branched C6-13 alcohol. It is also contemplated that the linear alcohol, and/or alkoxylate thereof, may be used to the exclusion of the branched alcohol, and/or alkoxylate thereof. It is further contemplated that the branched alcohol, and/or alkoxylate thereof, may be used to the exclusion of the linear alcohol, and/or alkoxylate thereof. In a preferred embodiment, the linear or branched C6-13 alcohol is a C6-C10 alcohol (or mixtures of such alcohols).

This component may be described as an alcohol that is capped with (or includes) any number of moles of an alkylene oxide. In various embodiments, the alcohol is capped with approximately 1 to 20 moles of an alkylene oxide. In other embodiments, the alcohol is capped with about 1, 2, 3, 4, 5, 6, 7, 8, 9, 10, 11, 12, 13, 14, 15, 16, 17, 18, 19, or 20 moles of an alkylene oxide. In still other embodiments, this amount is from about 2 to about 19, about 3 to about 18, about 4 to about 17, about 5 to about 16, about 6 to about 15, about 7 to about 14, about 8 to about 13, about 9 to about 12, or about 10 to about 11, moles of alkylene oxides. In other embodiments, the moles of alkylene oxide is from about 1 to about 35, about 1 to about 30, about 1 to about 25, about 1 to about 20, about 1 to about 15, about 1 to about 10, about 1 to about 5, about 5 to about 40, about 5 to about 35, about 5 to about 30, about 5 to about 25, about 5 to about 20, about 5 to about 15, about 5 to about 10, about 10 to about 40, about 10 to about 35, about 10 to about 30, about 10 to about 25, about 10 to about 20, about 10 to about 15, about 15 to about 40, about 15 to about 35, about 15 to about 30, about 15 to about 25, about 15 to about 20, about 20 to about 40, about 20 to about 35, about 20 to about 30, about 20 to about 25, about 25 to about 40, about 25 to about 35, about 25 to about 30, about 30 to about 40, about 35 to about 40, moles.

In various embodiments, the alkylene oxide may be described as ethylene oxide, propylene oxide, butylene oxide, or combinations thereof. As such, this component may be described as an alcohol ethoxylate, alcohol propoxylate, or alcohol butoxylate. This component may include a single type of alkylene oxide or multiple types. For example, this component may include only ethylene oxide, propylene oxide, or butylene oxide, or may include one or more blocks of ethylene oxide, propylene oxide, and/or butylene oxide, in any order or combination. Each block may be of any number of moles. In various embodiments, one or more blocks may independently have any number of moles as is described immediately above. It is contemplated that this component may be alkoxylated with only ethylene oxide, with only propylene oxide, with only butylene oxide, with a combination of ethylene oxide and propylene oxide, with a combination of ethylene oxide and butylene oxide, or with a combination of propylene oxide and butylene oxide. The alkoxylation may be further described as random or block or may include both random and block alkoxylation. In various non-limiting embodiments, all values, both whole and fractional, between and including all of the above, are hereby expressly contemplated for use herein. In a preferred embodiment, the alkoxylate is exclusively ethoxylate. In a more preferred embodiment, the linear or branched C6-13 alcohol is a C6-10 alcohol (or mixtures of such alcohols) with 10 or fewer ethoxylation units.

In one embodiment, the alcohol is hexanol. In another embodiment, the alcohol is 2-ethylhexanol. In another embodiment, this component is alkoxylated hexanol. In another embodiment, this component is alkoxylated 2-ethylhexanol. In another embodiment, this component is ethoxylated hexanol. In another embodiment, this component is ethoxylated 2-ethylhexanol. In still other embodiments, this component is a C10 alcohol or any isomer thereof. In another embodiment, this component is an alkoxylated C10 alcohol or any isomer thereof. Alternatively, this component may be an ethoxylated C10 alcohol or any isomer thereof, e.g. that is ethoxylated with about 5, 6, 7, 8, 9, or 10 moles of ethylene oxide.

In various embodiments, the alkoxylation unit in the linear or branched C6-13 alcohol alkoxylate is about 1 to about 10, typically from about 2 to about 8, most typically from about 3 to about 6. In one embodiment the linear or branched C6-13 alcohol alkoxylate is an ethoxylate.

In one embodiment, the (2) at least one linear or branched C6-13 alcohol or alkoxylate includes, consists essentially of, or consists of, hexanol.

In one embodiment, the (2) at least one linear or branched C6-13 alcohol or alkoxylate includes, consists essentially of, or consists of, an alkoxylate of 2-ethylhexanol.

In another embodiment, the alkoxylate of 2-ethylhexanol includes, consists essentially of, or consists of, ethoxylated 2-ethylhexanol.

In a further embodiment, the ethoxylated 2-ethylhexanol is ethoxylated with an average of about 3 to about 5 moles of ethylene oxide per mole of 2-ethylhexanol.

In a further embodiment, the (2) at least one linear or branched C6-13 alcohol or alkoxylate includes, consists essentially of, or consists of, an alkoxylate of a branched C10 alcohol.

In another embodiment, the alkoxylate of the branched C10 alcohol includes, consists essentially of, or consists of, an ethoxylated branched C10 alcohol.

In another embodiment, the ethoxylated branched C10 alcohol is ethoxylated with an average of about 6 to about 8 moles of ethylene oxide per mole of the branched C10 alcohol.

In another embodiment, the linear C6-13 alcohols may be chosen from 1-heptanol (enanthic alcohol, 7 carbon atoms), 1-octanol (capryl alcohol, 8 carbon atoms), 1-nonanol (pelargonic alcohol, 9 carbon atoms), 1-decanol (decyl alcohol, capric alcohol, 10 carbon atoms), 1-undecanol (hendecanol, 11 carbon atoms), 1-dodecanol (lauryl alcohol, 12 carbon atoms), and combinations thereof.

In another embodiment, the branched C6-13 alcohols may be chosen from 2-ethylhexyl alcohol, isooctanol such as Exxal 8, isononyl alcohol such as Exxal 9, isodecanol such as Exxal 10, 2-propylheptanol, iso-dodecanol such as Exxal 12, iso-tridecyl alcohol such as Exxal 13, and combinations thereof.

### (3) Salt of Glufosinate

Referring now to (3), the salt of glufosinate is not particularly limited and may be any known in the art. This component may be, include, consist essentially of, or consist of, the salt of glufosinate. In various embodiments, this salt is an ammonium salt. In other embodiments, the salt is chosen from amine, lithium, sodium, ammonium, potassium, isopropylamine, and/or dimethylamine salts. However, any salt known in the art can be used. Glufosinate is known in the art as a racemic mixture of D- and L-phosphinothricin. The ammonium salt of glufosinate is widely known as phosphinothricin, or PPT, and used as the active ingredient in broad-spectrum herbicides. In one embodiment, this salt is known as ammonium salt, glufosinate-ammonium. In other embodiments, it is contemplated that the non-salt version of glufosinate can be used. This non-salt version may be any known in the art. In other embodiments, the glufosinate can be a L-glufosinate or a mixture of D-glufosinate and L-glufosinate.

### (4) At Least One Linear or Branched C8-13 Alkyl Ether Sulfate

Referring now to (4), the at least one linear or branched C8-13 alkyl ether sulfate is not particularly limited and may be any known in the art. The disclosure may utilize one or more than one of a linear C8-13 alkyl ether sulfate and/or a branched C8-C13 alkyl ether sulfate, so long as at least one of the above is present.

It is contemplated that the at least one linear or branched C8-13 alkyl ether sulfate may be utilized to the exclusion of another C8-13 alkyl ether sulfate. For example, the linear C8-13 alkyl ether sulfate may be used to the exclusion of the branched C8-13 alkyl ether sulfate. Alternatively, the branched C8-13 alkyl ether sulfate may be used to the exclusion of the linear C8-13 alkyl ether sulfate.

This component may be, include, consist essentially of, or consist of, the at least one linear C8-13 alkyl ether sulfate. For example, this component may be, include, consist essentially of, or consist of, a linear alkyl ether sulfate having 8, 9, 10, 11, 12, or 13 carbon atoms or any range thereof.

Alternatively, this component may be, include, consist essentially of, or consist of, a branched alkyl ether sulfate having 8, 9, 10, 11, 12, or 13 carbon atoms or any range thereof.

All isomers of the aforementioned compounds are also expressly contemplated for use herein. In various embodiments, this component may be described as an anionic surfactant. In various non-limiting embodiments, all values, both whole and fractional, between and including all of the above, are hereby expressly contemplated for use herein.

For example, this component may have a formula such as CH₃(CH₂)ₓCH₂(OCH₂CH₂)ₙOSO₃M, wherein M is any suitable ion known in the art (e.g. Na or similar), x is 6, 7, 8, 9, 10, or 11, and n is from about 1 to about 10, about 2 to about 9, about 3 to about 8, about 4 to about 7, or about 5 to about 6.

In various embodiments, the alkyl ether sulfate is further defined as sodium laureth sulfate (SLES) (also known as sodium lauryl ether sulfate) having the formula: CH₃(CH₂)₁₀CH₂(OCH₂CH₂)ₙOSO₃Na wherein n is from about 1 to about 10, about 2 to about 9, about 3 to about 8, about 4 to about 7, or about 5 to about 6.

In another embodiment, the alkyl ether sulfate is sodium laureth sulfate that has been ethoxylated with about 2 to about 4 moles of ethylene oxide.

In various non-limiting embodiments, all values, both whole and fractional, between and including all of the above, are hereby expressly contemplated for use herein.

In various embodiments, the alkyl ether sulfate has a C₈-C₁₃ backbone that is ethoxylated with from about 1 to about 10 moles of ethylene oxide. Alternatively, the alkyl ether sulfate may be described as having a C₈-C₁₃ backbone and about 1 to 10 moles of ethylene oxide units bonded thereto. Various mixtures of alkyl ether sulfates may also be used wherein different length backbones are utilized. In various embodiments, the backbone is ethoxylated with about 1, 2, 3, 4, 5, 6, 7, 8, 9, 10, 11, 12, 13, 14, 15, 16, 17, 18, 19, or 20 moles of an ethylene oxide. In still other embodiments, this amount is from about 2 to about 19, about 3 to about 18, about 4 to about 17, about 5 to about 16, about 6 to about 15, about 7 to about 14, about 8 to about 13, about 9 to about 12, or about 10 to about 11, moles of ethylene oxide.

Alkyl ether sulfates are anionic surfactants. Suitable counterions in these anionic compounds are sodium or potassium, ammonium or organically substituted ammonium ions such as alkylammonium, dialkylammonium, trialkylammonium, for example trimethylammonium, isopropylammonium can be used. Other cationic groups such as the trimesium ion (known from sulfosate) or alkoxylated ammonium ions are also suitable for use.

In various embodiments, the linear or branched C8-13 alkyl ether sulfate includes, but is not limited to, 2-ethylhexyl ether sulfate, decyl ether sulfate, lauryl ether sulfate, and tridecyl ether sulfate. In one embodiment, the alkyl ether sulfate is lauryl ether sulfate. In other embodiments, the ethoxylation units in the ether sulfate is typically from about 1 to about 7, typically from about 2 to about 5, and more typically from about 2 to about 4. In still other embodiments, counter ions for the alkyl ether sulfate includes, but not limited to sodium, potassium, ammonium, isopropylamine, or dimethylamine.

In various embodiments, the alkyl ether sulfate may be, include, consist essentially of, or consist of, n-octyl ethylene glycol ether sulfate, n-octyl diethylene glycol ether sulfate, n-octyl triethylene glycol ether sulfate, n-octyl tetraethylene glycol ether sulfate, n-octyl pentaethylene glycol ether sulfate, n-octyl hexaethylene glycol ether sulfate, n-octyl heptaethylene glycol ether sulfate, n-octyl octaethylene glycol ether sulfate, n-octyl nonaethylene glycol ether sulfate, n-octyl decaethylene glycol ether sulfate, 2-ethylhexyl ethylene glycol ether sulfate, 2-ethylhexyl diethylene glycol ether sulfate, 2-ethylhexyl triethylene glycol ether sulfate, 2-ethylhexyl tetraethylene glycol ether sulfate, 2-ethylhexyl pentaethylene glycol ether sulfate, 2-ethylhexyl hexaethylene glycol ether sulfate, 2-ethylhexyl heptaethylene glycol ether sulfate, 2-ethylhexyl octaethylene glycol ether sulfate, 2-ethylhexyl nonaethylene glycol ether sulfate, 2-ethylhexyl decaethylene glycol ether sulfate, n-nonyl ethylene glycol ether sulfate, n-nonyl diethylene glycol ether sulfate, n-nonyl triethylene glycol ether sulfate, n-nonyl tetraethylene glycol ether sulfate, n-nonyl pentaethylene glycol ether sulfate, n-nonyl hexaethylene glycol ether sulfate, n-nonyl heptaethylene glycol ether sulfate, n-nonyl octaethylene glycol ether sulfate, n-nonyl nonaethylene glycol ether sulfate, n-nonyl decaethylene glycol ether sulfate, C10 ethylene glycol ether sulfate, C10 diethylene glycol ether sulfate, C10 triethylene glycol ether sulfate, C10 tetraethylene glycol ether sulfate, C10 pentaethylene glycol ether sulfate, C10 hexaethylene glycol ether sulfate, C10 heptaethylene glycol ether sulfate, C10 octaethylene glycol ether sulfate, C10 nonaethylene glycol ether sulfate, C10 decaethylene glycol ether sulfate, C11 ethylene glycol ether sulfate, C11 diethylene glycol ether sulfate, C11 triethylene glycol ether sulfate, C11 tetraethylene glycol ether sulfate, C11 pentaethylene glycol ether sulfate, C11 hexaethylene glycol ether sulfate, C11 heptaethylene glycol ether sulfate, C11 octaethylene glycol ether sulfate, C11 nonaethylene glycol ether sulfate, C11 decaethylene glycol ether sulfate, C12 ethylene glycol ether sulfate, C12 diethylene glycol ether sulfate, C12 triethylene glycol ether sulfate, C12 tetraethylene glycol ether sulfate, C12 pentaethylene glycol ether sulfate, C12 hexaethylene glycol ether sulfate, C12 heptaethylene glycol ether sulfate, C12 octaethylene glycol ether sulfate, C12 nonaethylene glycol ether sulfate, C12 decaethylene glycol ether sulfate, C13 ethylene glycol ether sulfate, C13 diethylene glycol ether sulfate, C13 triethylene glycol ether sulfate, C13 tetraethylene glycol ether sulfate, C13 pentaethylene glycol ether sulfate, C13 hexaethylene glycol ether sulfate, C13 heptaethylene glycol ether sulfate, C13 octaethylene glycol ether sulfate, C13 nonaethylene glycol ether sulfate, C13 decaethylene glycol ether sulfate, or combinations thereof.

### Additional Surfactants

In other embodiments, the composition may include, or be free of, one or more additional surfactants not described above. For example, such an additional surfactant may be, include, consist essentially of, or consist of, nonionic surfactants which may include alkyl polyglucosides. Alkylphenols having 5 to 12 carbon atoms may also be used. In various non-limiting embodiments, all values, both whole and fractional, between and including all of the above, are hereby expressly contemplated for use herein.

In one embodiment, the composition further includes an additional surfactant that is not (2) or (4) described above. In another embodiment, the additional surfactant includes an alkyl polyglucoside, also known as an APG. This compound is not particularly limited and may be any known in the art. In various embodiments, the alkyl polyglucoside has the following structure:

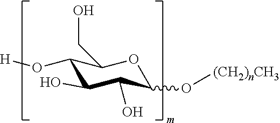

wherein m has an average value of from about 1 to about 3 and n has an average value of from about 5 to about 17. In various embodiments, m has an average value of about 1, about 2, or about 3. In other embodiments, n has an average value of about 5, about 6, about 7, about 8, about 9, about 10, about 11, about 12, about 13, about 14, about 15, about 16, or about 17. In various non-limiting embodiments, all values and ranges of value, both whole and fractional, between and including the aforementioned values, are hereby expressly contemplated for use herein.

In other embodiments, the alkyl polyglucoside is, includes, consists essentially of, or consists of, an oligomeric D-Glucopyranose C10-16 alkyl glycoside. This may be alternatively described as a C10-C16-alkyl polyglucoside. In other embodiments, the alkyl polyglucoside is, includes, consists essentially of, or consists of, an oligomeric D-Glucopyranose C8-C10-alkyl glycoside. This may be alternatively described as a C8-C10-alkyl polyglucoside. In other embodiments, the alkyl polyglucoside is, includes, consists essentially of, or consists of, an oligomeric D-Glucopyranose C10-C16-alkyl glucoside. This may be alternatively described as a C10-C16-alkyl polyglucoside.

In other embodiments, the additional surfactant is chosen from nonionic and ionic surfactants, such as polysorbates, alkyl ether sulfates, alkyl- and/or arylsulfonates, alkyl sulfates, ester sulfonates (sulfo-fatty acid esters), anionic sulfosuccinic acid surfactants, mono/di glyceride ethoxylates, silicone- and/or silane-based surface-active compounds, ether carboxylic acids and alkyl(ether) phosphates.

In still other embodiments, other contemplated surfactants include, but are not limited to, nonionic surfactants other than the linear or branched C6-13 alkoxylate, anionic surfactant other than the C8-13 alkyl ether sulfate such as alpha-olefin sulfonates, sulfosuccinates, and alkyl phosphate esters, nitrogen including surfactants such as amphoteric surfactants, alkylamine oxides, alkyl amine betaines, alkylamine alkoxylates, alkanol amide ethoxylates, and alkyl amidoamine ethoxylates, and combinations thereof.

In various embodiments, the use concentration of actives of one or more surfactants may be from about 0.05% to about 1%, typically about 0.1 to about 0.5%, and more typically about 0.2 to about 4% in % active basis. In various non-limiting embodiments, all values, both whole and fractional, and ranges of values, including and between those set forth above, are hereby expressly contemplated for use herein.

### Additives

Other additives can be present in, or absent from, the composition. Non-limiting examples include defoamers, diluents, compatibility agents, biocides, thickeners, drift control agents, dyes, fragrance, chelating agents, inert materials, such as tackifiers, wetting agents, dispersants, emulsifiers, penetrants, preservatives and antifreeze agents, fillers, carriers and colorants, evaporation inhibitors and pH-(buffer, acids and bases), viscosity-modifying agents, antifoams, and/or combinations thereof. In various embodiments, customary formulation auxiliaries include inert materials, antifreeze agents, evaporation inhibitors, preservatives, colorants, etc. In still other embodiments, the additive is chosen from defoamers, stickers, fertilizers, drift control agents, and combinations thereof. The weight percents of these optional additives may be chosen by those of skill in the art. In various embodiments, the weight percent of any one or more optional additives may be from about 0.01 to about 1, about 0.05 to about 0.5, or about 0.1 to about 0.3, weight percent actives based on a total weight of the composition. However, it is also contemplated that the weight percent of one or more optional additives may be greater than or less than the amounts described above. In various non-limiting embodiments, all values, both whole and fractional, and ranges of values, including and between those set forth above, are hereby expressly contemplated for use herein.

### Solvents

It is also contemplated that composition may include, or be free of, one or more of solvents apart from water. In various embodiments, organic solvents or inorganic solvents or mixtures thereof can be used. In other embodiments, the solvent may be, include, consist essentially of, or consist of, In other embodiments, the solvent may be, include, consist essentially of, or consist of, polar protic or aprotic polar solvents and mixtures thereof including aliphatic alcohols, such as, for example, lower alkanols, such as methanol, ethanol, propanol, isopropanol and butanol, or polyhydric alcohols, such as ethylene glycol, glycerol, polar ethers, such as tetrahydrofuran (THF), alkylene glycol monoalkyl ethers and alkylene glycol dialkyl ethers, such as, for example, propylene glycol monomethyl ether, propylene glycol monoethyl ether, ethylene glycol monomethyl ether or ethylene glycol monoethyl ether, diglyme and tetraglyme; amides, such as dimethylformamide (DMF), dimethylacetamide, dimethylcaprylamide, dimethylcaprinamide (®Hallcomide) and N-alkylpyrrolidones; ketones, such as acetone. In other embodiments, the solvent may be, include, consist essentially of, or consist of, methanol, ethanol, n- and isopropanol, n-, iso-, t- and 2-butanol, or combinations thereof. In other embodiments, the solvent may be, include, consist essentially of, or consist of, fully or largely water-miscible solvents or solvent mixtures. In other embodiments, the solvent may be, include, consist essentially of, or consist of, polar organic solvents, such as N-methylpyrrolidone and Dowanol® PM (propylene glycol monomethyl ether). In other embodiments, the typical organic solvent may be, include, consist essentially of, or consist of, 1-Methoxy-2-propanol (propylene glycol methyl ether).

In various embodiments, this component is present in an amount of from 0.01-0.5, 0.02-0.1, weight percent actives based on a total weight of the concentrate or composition. In various non-limiting embodiments, all values, both whole and fractional, between and including all of the above, are hereby expressly contemplated for use herein.

### Agrochemicals

In various embodiments, the composition may include, or be free of, one or more agrochemicals that is different from the (salt of the) glufosinate. As used herein, an agrochemical is a chemical used in agricultural compositions. Non-limiting examples of agrochemicals include fertilizers, micronutrients, activator adjuvants or potentiators, drift control agents, emulsifiers, deposition aids, water conditioners, wetting agents, dispersants, compatibility agents, suspension aids, pesticides such as herbicides, fungicides, and insecticides, and growth inhibitors. In one embodiment, the agrochemical is chosen from herbicides, fungicides, insecticides and combinations thereof. In another embodiment, the herbicide is chosen from glyphosate, dicamba, glufosinate, 2,4-D, and combinations thereof.

In various embodiments, suitable herbicides include, but are not limited to, acetochlor, acifluorfen, aclonifen, alachlor, ametryn, amidosulfuron, aminopyralid, amitrole, anilofos, asulam, atrazine, azafenidin, azimsulfuron, benazolin, benfluralin, bensulfuron-methyl, bentazone, bifenox, binalafos, bispyribac-sodium, bromacil, bromoxynil, butachlor, butroxidim, cafenstrole, carbetamide, carfentrazone-ethyl, chloridazon, chlorimuron-ethyl, chlorobromuron, chlorotoluron, chlorsulfuron, cinidon-ethyl, cinosulfuron, clethodim, clomazone, clopyralid, cloransulam-methyl, clorsulfuron, cyanazine, cycloate, cyclosulfamuron, cycloxydim, dalapon, desmedipham, dicamba, dichlobenil, dichlormid, diclosulam, diflufenican, dimefuron, dimepipeate, dimethachlor, dimethenamid, diquat, diuron, esprocarb, ethalfluralin, cthametsulfuron-methyl, ethofumesate, ethoxysulfuron, fentrazamide, flazasulfuron, florasulam, fluchloralin, flufenacet, flumetsulam, flumioxazin, fluometuron, flupyrsulfuron-methyl, flurochloridone, fluroxypyr, flurtamone, fomesafen, foramsulfuron, hexazinone, imazamethabenz-m, imazamox, mazapic, imazapyr, imazaquin, imazethapyr, imazosulfuron, iodosulfuron, ioxynil, isoproturon, isoxaben, isoxaflutole, Lactofen, lenacil, linuron, mefenacet, mesosulfuron-methyl, mesotrione, metamitron, metazachlor, methabenzthiazuron, metobromuron, metolachlor, metosulam, metoxuron, metribuzin, metsulfuron-methyl, molinate, MSMA, napropamide, nicosulfuron, norflurazon, oryzalin, oxadiargyl, oxadiazon, oxasulfuron, oxyfluorfen, paraquat, pendimethalin, phenmedipham, picloram, pretilachlor, profoxydim, prometryn, propanil, propisochlor, propoxycarbazone, propyzamide, prosulfocarb, prosulfuron, pyraflufen-ethyl, pyrazosulfuron, pyridate, pyrithiobac, quinclorac, quinmerac, rimsulfuron, sethoxydim, simazine, s-metolachlor, sulcotrione, sulfentrazone, sulfosulfuron, tebuthiuron, tepraloxydim, terbuthylazine, terbutryn, thifensulfuron-methyl, thiobencarb, tralkoxydim, tri-allate, triasulfuron, tribenuron-methyl, triclopyr, trifloxysulfuron, trifluralin, triflusulfuron-methyl, tritosulfuron, and combinations and combinations thereof. Typical herbicides are acetochlor, atrazine, dicamba, paraquat, glyphosate, 2,4-D and combinations and combinations thereof. In other embodiments, typical herbicides include, but are not limited to, glyphosate, 2,4-D, dicamba, pelargonic acid, and combinations thereof. More typical herbicides are 2,4-D, atrazine, dicamba, glyphosate, and combinations and combinations thereof. When the herbicide is an acid, it can be used in the acid form though it is typical that the herbicide be in the salt form chosen from at least one of the group of an amine, lithium, sodium, ammonium or potassium. It shall be pointed out that when a pesticide appears in the text as a general name without specifying the counterions, it means both its acid form and salt form throughout the specification.

In other embodiments, examples of suitable fungicides include, but are not limited to, acibenzolar-S-methyl, aldimorph, amisulbrom, anilazine, azaconazole, azoxystrobin, benalaxyl, benodanil, benomyl, benthiavalicarb, binapacryl, biphenyl, bitertanol, blasticidin-S, boscalid, bromuconazole, bupirimate, captafol, captan, carbendazim, carboxin, carpropamid, chloroneb, chlorothalonil, chlozolinate, copper, cyazofamid, cyflufenamid, cymoxanil, cyproconazole, cyprodinil, dichlofluanid, diclocymet, diclomezine, dicloran, dicthofencarb, difenoconazole, diflumetorim, dimethirimol, dimethomorph, dimoxystrobin, diniconazole, dinocap, dithianon, dodemorph, dodine, edifenphos, enestrobin, epoxiconazole, etaconazole, ethaboxam, ethirimol, ctridiazole, famoxadone, fenamidone, fenarimol, fenbuconazole, fenfuram, fenhexamid, fenoxanil, fenpiclonil, fenpropidin, fenpropimorph, fentin acetate, fentin chloride, fentin hydroxide, ferbam, ferimzone, fluazinam, fludioxonil, flumorph, fluopicolide, fluoxastrobin, fluquinconazole, flusilazole, flusulfamide, flutolanil, flutriafol, folpet, fosetyl-Al, fthalide, fuberidazole, furalaxyl, furametpyr, guazatine, hexaconazole, hymexazole, imazalil, imibenconazole, iminoctadine, iodocarb, ipconazole, iprobenfos (IBP), iprodione, iprovalicarb, isoprothiolane, isotianil, kasugamycin, kresoxim-methyl, laminarin, mancozeb, mandipropamid, maneb, material of biological, mepanipyrim, mepronil, meptyldinocap, metalaxyl, metalaxyl-M, metconazole, methasulfocarb, metiram, metominostrobin, metrafenone, mineral oils, organic oils, myclobutanil, naftifine, nuarimol, octhilinone, ofurace, origin, orysastrobin, oxadixyl, oxolinic acid, oxpoconazole, oxycarboxin, oxytetracycline, pefurazoate, penconazole, pencycuron, penthiopyrad, phophorous acid and, picoxystrobin, piperalin, polyoxin, potassium bicarbonate, probenazole, prochloraz, procymidone, propamocarb, propiconazole, propineb, proquinazid, prothiocarb, prothioconazole, pyraclostrobin, pyrazophos, pyribencarb, pyributicarb, pyrifenox, pyrimethanil, pyroquilon, quinoxyfen, quintozene (PCNB), salts, silthiofam, simeconazole, spiroxamine, streptomycin, sulphur, tebuconazole, teclofthalam, tecnazene (TCNB), terbinafine, tetraconazole, thiabendazole, thifluzamide, thiophanate, thiophanate-methyl, thiram, tiadinil, tolclofosmethyl, tolylfluanid, triadimefon, triadimenol, triazoxide, tricyclazole, tridemorph, trifloxystrobin, triflumizole, triforine, triticonazole, validamycin, valiphenal, vinclozolin, zineb, ziram, and zoxamide, and combinations and combinations thereof.

In still other embodiments, examples of suitable insecticides include, but are not limited to, kerosene or borax, botanicals or natural organic compounds (such as nicotine, pyrethrin, strychnine and rotenone), chlorinated hydrocarbon (such as DDT, lindane, chlordane), organophosphates (such as malathion and diazinon), carbamates (such as carbaryl and propoxur), fumigants (such as naphthalene) and benzene (such as mothballs), synthetic pyrethroids (such as bifenthrin and permethrin), neonicotinoids (such as imidacloprid, clothianidin, terpenoid (such as methoprene), and mixtures and combinations thereof. In still other embodiments, the composition may include or be free of a growth inhibitor.

In various embodiments, this component is present in an amount of from 0.05-1, or 0.1-0.5, weight percent actives based on a total weight of the concentrate or composition. In various non-limiting embodiments, all values, both whole and fractional, between and including all of the above, are hereby expressly contemplated for use herein.

### Method of Forming the Ready-to-Use Agricultural Composition

This disclosure provides a method of forming the ready-to-use agricultural composition including glufosinate. The method may be, include, consist essentially of, or consist of the step of combining: (1) water, the (2) at least one linear or branched C6-13 alcohol or alkoxylate thereof, the (3) salt of glufosinate, and the (4) at least one linear or branched C8-13 alkyl ether sulfate, to form the ready-to-use agricultural composition, wherein the concentration of each of (2), (3), and (4) is independently from about 0.05 to about 1, weight percent, based on a total weight of the ready-to-use agricultural composition. Each of (1)-(4) may be combined with one or more of the other of (1)-(4) in whole or in part. For example (2) may be added to (1), (3), and/or (4), before, during, or after combination with one or more of another of (1), (3), and/or (4). Each of (1)-(4) may be combined with any one or more of the other of (1)-(4) in any order.

In one embodiment, the method includes the aforementioned step of combining (1)-(4).

In another embodiment, the method consists essentially of the aforementioned step of combining (1)-(4). In various embodiments, the terminology “consisting essentially of” describes embodiments that are free of steps such as utilizing or combining or adding or more components that are not described herein and/or are described herein as optional, e.g. polymers, surfactants, pesticides, herbicides, fungicides, additives, etc.

In another embodiment, the method consists of the aforementioned step of combining (1)-(4).

It is also contemplated that the method may include or be free of one or more additional steps. The step of providing may be any known in the art including supplying, purchasing, pumping, transporting, etc. The method may also include the step of adding additional water to the composition or any one of (1)-(4) independent from the aforementioned step of combining (1)-(4). After combining (or mixing) the components, a ready-to-use product is obtained. The individual components can be mixed in any order of addition. For examples, the ready-to-use agricultural composition can be obtained by (1) mixing the liner or branched C6-13 alcohol or its alkoxylates with a commercial product (or a concentrate) including glufosinate and alkyl ether sulfate first, followed by dilution with water; (2) mixing the liner or branched C6-13 alcohol or its alkoxylates with water first, followed by mixing a commercial product (or a concentrate) including glufosinate and alkyl ether sulfate; or (3) mixing a commercial product (or a concentrate) including glufosinate and alkyl ether sulfate with water first, followed by mixing the liner or branched C6-13 alcohol or its alkoxylates. All combinations of mixing or combining (1)-(4) are expressly contemplated for use herein in various non-limiting embodiments.

In other embodiments, the method includes the step of providing a concentrate of (1), (3), and (4) prior to the step of combining (2) and additional water (1) with the concentrate to form the ready-to-use agricultural composition. Examples of the concentrates are commercial products of glufosinate. In one embodiment, the concentrate includes about 10 to about 40 weight percent actives of glufosinate (3) based on a total weight of the concentrate. In another embodiment, the concentrate includes about 13 to about 30 weight percent actives of (3) based on a total weight of the concentrate. In further embodiments, the concentrate includes about 10 to about 40, about 13 to about 35, or about 20 to about 30, weight percent actives of (3) based on a total weight of the concentrate. In various non-limiting embodiments, all values, both whole and fractional, between and including all of the above, are hereby expressly contemplated for use herein. In other embodiments, the concentrate includes about 10 to about 40 weight percent actives of (4) based on a total weight of the concentrate. In another embodiment, the concentrate includes about 13 to about 30 weight percent actives of (4) based on a total weight of the concentrate. In further embodiments, the concentrate includes about 10 to about 40, about 15 to about 38, or about 20 to about 35, weight percent actives of (4) based on a total weight of the concentrate.

In various non-limiting embodiments, all values, both whole and fractional, between and including all of the above, are hereby expressly contemplated for use herein.

In various embodiments, the method includes combining other suitable chemicals with (1)-(4).

In still other embodiments, this disclosure provides a method of maintaining the bioefficacy of glufosinate including (i) obtaining a ready-to-use agricultural composition defined in the disclosure and (ii) applying an effective amount of the composition to targeted plants to kill or control the plants.

In various embodiment, the ready-to-use agricultural composition exhibits an statistically meaningful efficacy (based on a mean separation—LSD method using at least 4 replicas) that is within about 10, 9, 8, 7, 6, 5, 4, 3, 2, or 1, % of the efficacy of a comparative composition that is free of (2).

For example, in various embodiments, in a ready-to-use product, besides water, there are typically two groups of ingredients, group A (e.g. glufosinate+alkyl ether sulfate+other additives such as APG and solvent) and group B (e.g. the liner or branched C6-13 alcohol or its alkoxylates). In various embodiments, relative to bioefficacy, it can be assumed that the bioefficacy (or % control) of A (i.e., without B) is 90%, merely for the sake of an explanatory example. In such an embodiment, the concept of maintaining the bioefficacy would typically mean that when the portion of A is replaced by B (e.g. 20 wt % actives of A is replaced by 20 wt % actives of B), the bioefficacy is still 90% or similar, ± about 0.1, 0.5, 1, 2, 3, 4, 5, 6, 7, 8, 9, or 10, %. In various embodiments, because B is less expensive than A, there is a cost saving to end users to achieve the same bioefficacy result. Throughout this disclosure, the terminology “efficacy” and “bioefficacy” can be used interchangeably. In various non-limiting embodiments, all values, both whole and fractional, between and including all of the above, are hereby expressly contemplated for use herein.

### EXAMPLES

### Example 1

Four samples (concentrates) were prepared and used in a greenhouse trial. The compositions of the four samples are shown below in Table 1. Each was sprayed at 44 fl oz/A on spring wheat.

Various ready-to-use samples were prepared by diluting the aforementioned concentrates (shaken before dilution) with water to 2% of the concentrates. All diluted samples are visually clear between about 0° C. and about 54° C. Four replicas were used for each data point. The % control results were rated at 1 WAT (week after treatment), 2 WAT, and 3 WAT. The compositions of the concentrates are shown below in Table 1.

TABLE 1

| | | | Ammonium | | |
|---|---|---|---|---|---|
| | Exxal- | 2-ethylhexyl | Glufosinate | Liberty | |
| Sample | 10 + 7EO | alcohol | (24.5%) | 280 SL | Comment |
| 1.1 | 10% | — | — | 90% | — |
| 1.2 | — | 10% | — | 90% | — |
| 1.3 | — | — | 100% | — | Negative |
| | | | | | control |
| 1.4 | — | — | — | 100% | Positive |
| | | | | | control |

“%” is wt % in all examples. In samples 1.1 and 1.2, 10% of Liberty 280 SL was replaced with 10% of branched alcohol (2-ethylhexyl alcohol) and by 10% alcohol alkoxylate (Exxal-10+7EO).

Sample 1.3 has the same ammonium glufosinate concentrate as in Liberty 280 SL and it serves as a negative control (no adjuvants added). A break-down of compositions for concentrates and their dilutions is shown in Table 1A below.

TABLE 1A

| | Exxal | 2- | | | 1- | | |
|---|---|---|---|---|---|---|---|
| | 10 + | ethylhexyl | Ammonium | | Methoxy- | | |
| | 7EO | alcohol | glufosinate | SLES | 2-propanol | APG | Water |
| Sample 1.1 | 10 | — | 22.05 | 28.44 | 0.9 | 8.82 | 39.79 |
| Ready-to-use | 0.2 | — | 0.441 | 0.569 | 0.018 | 0.176 | 98.596 |
| solution from | | | | | | | |
| Sample 1.1 | | | | | | | |
| Sample 1.2 | — | 10 | 22.05 | 28.44 | 0.9 | 8.82 | 39.79 |
| Ready-to-use | — | 0.2 | 0.441 | 0.569 | 0.018 | 0.176 | 98.596 |
| solution from | | | | | | | |
| Sample 1.2 | | | | | | | |
| Sample 1.3 | — | — | 24.5 | — | — | — | 75.5 |
| Ready-to-use | — | — | 0.49 | — | — | — | 99.51 |
| solution from | | | | | | | |
| Sample 1.3 | | | | | | | |
| Sample 1.4 | — | — | 24.5 | 31.6 | 1 | 9.8 | 33.1 |
| Ready-to-use | — | — | 0.49 | 0.632 | 0.02 | 0.196 | 98.662 |
| solution from | | | | | | | |
| Sample 1.4 | | | | | | | |

Exxal 10+7EO is an alcohol Exxal 10 (isodecanol) with 7 moles of ethylene oxide.

APG is alkyl polyglucoside used in Liberty 280 SL.

The aforementioned Samples are evaluated to determine efficacy. Efficacy results are shown in Table 1B below wherein % Control of wheat (a model monocot species) using various Samples sprayed at 44 fl oz/A is evaluated.

TABLE 1B

| | Wheat, 44 fl oz/A | | | | | |
|---|---|---|---|---|---|---|
| | 1 WAT | | 2 WAT | | 3 WAT | |
| | | Mean | | Mean | | Mean |
| | | separa- | | separa- | | separa- |
| | % | tion − | % | tion − | % | tion − |
| Sample | Control | LSD) | Control | LSD) | control | LSD) |
| 1.1 | 75 | a | 87 | a | 78 | a |
| 1.2 | 82 | a | 83 | ab | 78 | a |
| 1.3 | 1 | f | 13 | cd | 7 | de |
| 1.4 | 75 | a | 85 | a | 58 | b |

“% Control” is an averaged value such that each data point has an error bar (or uncertainty) associated with it. For this reason, the “Mean separation—LSD” is used to determine whether the difference in “% Control” is statistically significant.

If two data points share at least one letter, the two data points are statistically the same and cannot be directly differentiated or distinguished from one another. Alternatively, if two data points do not share at least one letter, they are statistically different from each other and can be directly differentiated or distinguished from one another.

In the above examples, at 3 WAT, the “mean separation—LSD” for samples 1.1 and 1.2 are “a” while the “Mean separation—LSD” for sample 1.4 (Liberty 280 SL) is “b”. Therefore samples 1.1 and 1.2 do not share any letter with sample 1.4. Therefore, these values can be directly differentiated or distinguished from one another statistically. This means that the data results for samples 1.1 and 1.2 are statistically different from the results for sample 1.4 (Liberty 280 SL). Therefore, the % controls (3 WAT) of “78” for samples 1.1 and 1.2 are better than the % control of “58” for sample 1.4 (Liberty 280 SL).

The data also shows that the % control of sample 1.4 (Liberty 280 SL) drops off significantly from “85” (letter “a” at 2 WAT) to “58” (letter “b” at 3 WAT) while the % controls of samples 1.1 and 1.2 do not drop off significantly. Significant drop off in % control is typically attributed to regrowth due to various reasons including insufficient amount of glufosinate applied.

### Example 2

Three additional samples (concentrates) were prepared and used in a greenhouse trial. The compositions of these three samples are shown in Table 2. They were sprayed at 22 fl oz/A on morning glory (a model dicot species) as described below.

The ready-to-use samples were prepared by diluting the aforementioned concentrates (shaken before dilution) with water to 1% of the concentrates. All diluted samples are visually clear between about 0° C. and about 54° C. Four replicas were used for each data point. The % control results were rated at 1 WAT, 2 WAT, and 3 WAT. Table 2 sets forth the compositions of these concentrates.

TABLE 2

| | | Ammonium | | |
|---|---|---|---|---|
| | | Glufosinate | Liberty | |
| Sample | Hexanol | (24.5%) | 280 SL | Comment |
| 2.1 | 10% | — | 90% | — |
| 2.2 | — | 100% | — | Negative control |
| 2.3 | — | — | 100% | Positive control |

A break-down of compositions for concentrates and their dilutions is shown in Table 2A below.

TABLE 2A

| | | Ammonium | | 1-Methoxy-2- | | |
|---|---|---|---|---|---|---|
| | Hexanol | glufosinate | SLES | propanol | APG | Water |
| Sample 2.1 | 10 | 22.05 | 28.44 | 0.9 | 8.82 | 39.79 |
| Ready-to-use | 0.1 | 0.2205 | 0.2844 | 0.009 | 0.0882 | 99.2979 |
| solution from | | | | | | |
| Sample 2.1 | | | | | | |
| Sample 2.2 | — | 24.5 | — | — | — | 75.5 |
| Ready-to-use | — | 0.245 | — | — | — | 99.755 |
| solution from | | | | | | |
| Sample 2.2 | | | | | | |
| Sample 2.3 | — | 24.5 | 31.6 | 1 | 9.8 | 33.1 |
| Ready-to-use | — | 0.2205 | 0.2844 | 0.009 | 0.0882 | 99.3979 |
| solution from | | | | | | |
| Sample 2.3 | | | | | | |

The APG used in Table 2A is the same as is described above in Table 1A.

The aforementioned Samples are evaluated to determine efficacy. Efficacy results are shown in Table 2B below wherein % Control of Morning Glory at using various Samples is evaluated.

TABLE 2B

| | Morning glory, 22 fl oz/A | | | | | |
|---|---|---|---|---|---|---|
| | 1 WAT | | 2 WAT | | 3 WAT | |
| | | Mean | | Mean | | Mean |
| | | separa- | | separa- | | separa- |
| | % | tion − | % | tion − | % | tion − |
| | control | LSD | control | LSD | control | LSD |
| 2.1 | 89 | ab | 97 | a | 96 | abc |
| 2.2 | 40 | gh | 60 | e | 45 | ef |
| 2.3 | 84 | bcd | 91 | ab | 83 | cd |

In the above examples, at 3 WAT, the “mean separation-LSD” for sample 2.1 and is “abc” while the “Mean separation—LSD” for sample 2.3 (Liberty 280 SL) is “cd”. Therefore samples 2.1 and 2.3 share a letter “c”. Therefore, the % control of “96” for samples 2.1 are statistically the same as the % control of “58” for sample 2.3 (Liberty 280 SL).

The data also shows that the % control of sample 2.3 (Liberty 280 SL) drops off significantly from “91” (letter “ab” at 2 WAT) to “83” (letter “cd” at 3 WAT) while the % control of samples 2.1 does not drop off significantly.

### Example 3

Six samples (concentrates) were prepared and used in a greenhouse trial. The compositions of these six samples are shown in Table 3 below. These compositions were sprayed at 22 fl oz/A on both spring wheat and morning glory.

The ready-to-use samples were prepared by diluting the concentrates (shaken before dilution) with water to 1% of the concentrates. All diluted samples are visually clear between about 0° C. and about 54° C. Four replicas were used for each data point. The % control results were rated after 11 days and 18 days (DAT). Table 3 sets forth the compositions of the concentrates.

TABLE 3

| | Exxal 10 + | | | | |
|---|---|---|---|---|---|
| | 7EO:hexanol = | 2- | Ammonium | | |
| | 5:5 by weight | ethylhexyl- | glufosinate | Liberty | |
| Sample | actives | 4EO | (24.5%) | 280 SL | Comment |
| 3.1 | 10% | — | — | 90% | — |
| 3.2 | 20% | — | — | 80% | — |
| 3.3 | — | 10% | — | 90% | — |
| 3.4 | — | 20% | — | 80% | — |
| 3.5 | — | — | 100% | — | Negative |
| | | | | | control |
| 3.6 | — | — | — | 100% | Positive |
| | | | | | control |

A break-down of compositions for concentrates and their dilutions is shown in Table 3A below.

TABLE 3A

| | Exxal | | | | | | |
|---|---|---|---|---|---|---|---|
| | 10 + 7EO:hex- | 2- | | | 1- | | |
| | anol = | ethylhexyl- | Ammonium | | Methoxy- | | |
| | 5:5 | 4EO | glufosinate | SLES | 2-propanol | APG | Water |
| Sample 3.1 | 10 | — | 22.05 | 28.44 | 0.9 | 8.82 | 39.79 |
| Ready-to-use | 0.1 | — | 0.2205 | 0.284 | 0.009 | 0.088 | 99.298 |
| solution from | | | | | | | |
| Sample 3.1 | | | | | | | |
| Sample 3.2 | 20 | — | 19.6 | 25.28 | 0.8 | 7.84 | 26.48 |
| Ready-to-use | 0.2 | — | 0.196 | 0.253 | 0.008 | 0.078 | 99.265 |
| solution from | | | | | | | |
| Sample 3.2 | | | | | | | |
| Sample 3.3 | — | 10 | 22.05 | 28.44 | 0.9 | 8.82 | 39.79 |
| Ready-to-use | — | 0.1 | 0.2205 | 0.284 | 0.009 | 0.088 | 99.298 |
| solution from | | | | | | | |
| Sample 3.3 | | | | | | | |
| Sample 3.4 | — | 20 | 19.6 | 25.28 | 0.8 | 7.84 | 26.48 |
| Ready-to-use | — | 0.2 | 0.196 | 0.253 | 0.008 | 0.078 | 99.265 |
| solution from | | | | | | | |
| Sample 3.4 | | | | | | | |
| Sample 3.5 | — | — | 24.5 | — | — | — | 75.5 |
| Ready-to-use | — | — | 0.245 | — | — | — | 99.755 |
| solution from | | | | | | | |
| Sample 3.5 | | | | | | | |
| Sample 3.6 | | | 24.5 | 31.6 | 1 | 9.8 | 33.1 |
| Ready-to-use | | | 0.2205 | 0.284 | 0.009 | 0.088 | 99.398 |
| solution from | | | | | | | |
| Sample 3.6 | | | | | | | |

Exxal 10+7EO is the same as is described above.

2-ethylhexyl-4EO is 2-ethylhexanol ethoxylated with 4 moles of ethylene oxide.

The APG is the same as is described above.

The aforementioned Samples are evaluated to determine efficacy. Efficacy results are shown in Table 3B below wherein % Control of spring wheat and Morning glory at 22 fl oz/A using various Samples is evaluated.

TABLE 3B

| | Wheat, % Control | | | | Morning Glory, % Control | | | |
|---|---|---|---|---|---|---|---|---|
| | 11 | M.S. | 18 | M.S. | 11 | M.S. | 18 | M.S. |
| Sample | DAT | LSD | DAT | LSD | DAT | LSD | DAT | LSD |
| 3.1 | 76 | cde | 92 | abc | 74 | abc | 74 | bcd |
| 3.2 | 71 | def | 84 | bcd | 85 | abc | 83 | abc |
| 3.3 | 80 | bcd | 92 | abc | 75 | abc | 58 | de |
| 3.4 | 86 | a-d | 97 | ab | 81 | abc | 80 | abc |
| 3.5 | 62 | efg | 76 | d | 58 | bcd | 55 | de |
| 3.6 | 91 | abc | 98 | ab | 83 | abc | 85 | abc |

In the above examples for wheat control at 18 DAT, the “mean separation—LSD” for samples 3.1-3.4 share at least one letter “b”. Therefore, the % controls for samples 3.1-3.4 are statistically the same as the % control of sample 3.6 (Liberty 280 SL).

In the above examples for morning glory control at 18 DAT, the “mean separation—LSD” for samples 3.1, 3.2, and 3.4 share at least two letter “bc”. Therefore, the % controls for samples 3.1, 3.2, and 3.4 are statistically the same as the % control of sample 3.6 (Liberty 280 SL).

The data also shows that from 10% to 20% replacement of Liberty 280 SL by 2-ethylhexyl-4EO (samples 3.3 and 3.4), the % controls improve for both wheat and morning glory controls. This effect is particularly apparent in morning glory control.

It is well-known in the art that only certain anionic surfactants such as SLES can effectively enhance the bioefficacy of glufosinate as demonstrated in the commercial products throughout the world. Through the above examples, it is shown that it is unexpected that replacing Liberty 280 SL, an expensive glufosinate product, with inexpensive hexanol, 2-ethylhexyl-4EO, Exxal 10-7EO, or hexanol/Exxal 10-7EO (1:1), can enhance or maintain the bioefficacy of Liberty 280 SL on wheat and morning glory depending on the percentage of replacement. In some cases, 20% replacement of Liberty 280 SL has shown advantage over 10% replacement. It is believed the enhanced bioefficacy of glufosinate in the examples is due to the combined effect of these alcohol and alcohol ethoxylates and the main glufosinate adjuvant SLES.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method of forming a ready-to-use agricultural composition comprising glufosinate, said method comprising the step of:
combining: (1) water, (2) at least one linear or branched C6-13 alcohol or alkoxylate thereof, (3) a salt of glufosinate, and (4) at least one linear or branched C8-13 alkyl ether sulfate, to form the ready-to-use agricultural composition,
wherein the concentration of each of (2), (3), and (4) is independently from about 0.05 to about 1 weight percent actives, based on a total weight of the ready-to-use agricultural composition.

2. The method of claim 1 wherein the ready-to-use agricultural composition exhibits an efficacy that is statistically the same as the efficacy of a comparative composition that is free of (2).

3. The method of claim 1 wherein the concentration of each of (2), (3), and (4) is independently from about 0.1 to about 0.7 weight percent actives, based on a total weight of the ready-to-use agricultural composition.

4. The method of claim 1 wherein the concentration of each of (2), (3), and (4) is independently from about 0.2 to about 0.4 weight percent actives, based on a total weight of the ready-to-use agricultural composition.

5. The method of claim 1 wherein (2) comprises hexanol.

6. The method of claim 1 wherein (2) comprises an alkoxylate of 2-ethylhexanol.

7. The method of claim 6 wherein the alkoxylate of 2-ethylhexanol is ethoxylated 2-ethylhexanol.

8. The method of claim 7 wherein the ethoxylated 2-ethylhexanol is ethoxylated with an average of about 3 to about 5 moles of ethylene oxide per mole of 2-ethylhexanol.

9. The method of claim 1 wherein (2) comprises an alkoxylate of a branched C10 alcohol.

10. The method of claim 9 wherein the alkoxylate of the branched C10 alcohol is an ethoxylated branched C10 alcohol.

11. The method of claim 10 wherein the ethoxylated branched C10 alcohol is ethoxylated with an average of about 6 to about 8 moles of ethylene oxide per mole of the branched C10 alcohol.

12. The method of claim 1 further comprising the step of providing a concentrate of (1), (3), and (4) prior to the step of combining (2) and an additional amount of (1) and the concentrate to form the ready-to-use agricultural composition.

13. The method of claim 12 wherein the concentrate comprises about 10 to about 40 weight percent actives of (3) based on a total weight of the concentrate.

14. The method of claim 13 wherein the concentrate comprises about 13 to about 35 weight percent actives of (3) based on a total weight of the concentrate.

15. The method of claim 12 wherein the concentrate comprises about 10 to about 40 weight percent actives of (4), based on a total weight of the concentrate.

16. The method of claim 1 wherein the ready-to-use agricultural composition further comprises an organic solvent.

17. The method of claim 16 wherein the organic solvent comprises 1-methoxy-2-propanol.

18. The method of claim 1 wherein the ready-to-use agricultural composition further comprises an additional surfactant that is not (2) or (4).

19. The method of claim 18 wherein the additional surfactant comprises an alkyl polyglucoside.

20. A ready-to-use agricultural composition formed from the method of claim 1.
